(19) United States
(12) Patent Application Publication
(10) Pub. No.: US 2026/0184346 A1
(43) Pub. Date: Jul. 2, 2026

(54) METHOD FOR CONTROLLING AN AUTONOMOUS VEHICLE, AND VEHICLE

(71) Applicant: ZF CV Systems Global GmbH, Bern (CH)

(72) Inventor: Julian van Thiel, Grossburgwedel (DE)

(21) Appl. No.: 19/383,459

(22) Filed: Nov. 7, 2025

Related U.S. Application Data
(63) Continuation of application No. PCT/EP2024/061042, filed on Apr. 23, 2024.

(30) Foreign Application Priority Data
May 8, 2023 (DE) 10 2023 111 866.8

(51) Int. Cl. B60W 60/00; B60W 50/023; G07C 5/08

(52) U.S. Cl. CPC B60W 60/00186; B60W 50/023; G07C 5/0816; B60W 2300/14; B60W 2420/403; B60W 2420/408; B60W 2510/18; B60W 2510/202; B60W 2510/205; B60W 2520/10; B60W 2520/105; B60W 2520/125; B60W 2552/15; B60W 2552/30; B60W 2552/40; B60W 2555/20; B60W 2556/45

(57) ABSTRACT

A method is for controlling a vehicle having a plurality of subsystems. The vehicle is autonomously controlled by a motion control unit, which is configured to determine a setpoint trajectory depending on a mission specification and/or a route specification and to communicate with and/or activate at least some of the subsystems depending on the setpoint trajectory, so that the vehicle moves from a starting point to a destination. The method includes: monitoring at least one subsystem of the vehicle for the presence of a fault, and, in the event that a fault has been detected in the at least one monitored subsystem, due to which the subsystem concerned can then be operated at a reduced functional level only: classifying the at least one fault into a fault class; adapting the mission specification and/or the route specification and/or the setpoint trajectory depending on the fault class of the respectively detected fault.

### CROSS-REFERENCE TO RELATED APPLICATIONS

This application is a continuation application of international patent application PCT/EP 2024/061042, filed Apr. 23, 2024, designating the United States and claiming priority from German application 10 2023 111 866.8, filed May 8, 2023, and the entire content of both applications is incorporated herein by reference.

### TECHNICAL FIELD

The disclosure relates to a method for controlling an autonomous vehicle, and a vehicle to carry out the method.

### BACKGROUND

In an autonomous vehicle, in which a plurality of subsystems are normally arranged, a mission specification is usually read in, coordinated by a motion control unit, and/or a route specification is generated from it, corresponding, for example, to a setpoint trajectory. The motion control unit then communicates with at least some of the subsystems and/or automatically controls at least some of the subsystems depending on this setpoint trajectory such that the vehicle moves along a road from a starting point to a destination point in order to implement the mission specification and/or the route specification. If faults occur in such an automated system, the vehicle is usually transferred to a safe state, for example parked at the roadside, regardless of the type of fault.

DE 10 2019 213 512 A1 describes the monitoring of the service braking system for a fault and, if a fault is detected in the service braking system, the provision of a backup function via a backup braking system, thereby maintaining driving operation.

However, no other adjustment of the driving operation is provided. Further backup functions as a replacement for certain braking functions in the vehicle are described in DE 10 2011 016 740 A1.

### SUMMARY

It is an object of the present disclosure to provide a method for controlling an autonomous vehicle, with which safe operation of the vehicle can be ensured even in the event of a fault. It is a further object to provide a vehicle.

These objects are achieved by various embodiments of the disclosure.

A method is thus provided according to the disclosure for controlling a vehicle having a plurality of subsystems, wherein the vehicle is autonomously controlled by a motion control unit, wherein the motion control unit is configured to determine a setpoint trajectory depending on a mission specification and/or a route specification and to communicate with at least some of the subsystems and/or to activate at least some of the subsystems depending on the setpoint trajectory, so that the vehicle moves along a road from a starting point to a destination point in order to implement the mission specification and/or the route specification, wherein the method includes at least the following steps:
monitoring at least one subsystem of the vehicle for the presence of a fault, and, in the event that at least one fault has been detected in the at least one monitored subsystem, due to which the subsystem concerned can then be operated at a reduced functional level only;
classifying the at least one fault into a fault class;
adapting the mission specification and/or the route specification and/or the setpoint trajectory on the basis of the fault class of the respectively detected fault.

Thus, when a fault is detected in one of the subsystems of the vehicle, the mission or the route or the setpoint trajectory of the vehicle is advantageously first adapted as a fault response or mitigation measure, wherein this is done depending on the impact of the fault on the driving behavior of the vehicle or the functional level to which the subsystem is restricted. According to the disclosure, the risk arising from the vehicle in the event of a fault with the reduced functional level is therefore initially minimized by adapting the mission or route or setpoint trajectory accordingly, If, for example, a fault occurs which has a moderate impact on driving behavior, it can be provided, as a mitigation measure or fault response, to divert the vehicle to secondary routes or routes that are usable even with the fault or the reduced functional level. In the case of minor or more impactful faults or a slightly or severely reduced functional level of the subsystem concerned, the mitigation measures or the fault response will then differ according to the fault class.

Furthermore, it can preferably be provided that, if a fault is detected in the at least one monitored subsystem, due to which the subsystem concerned can be operated at a reduced functional level only, a backup function is activated by the subsystem concerned and/or by one of the other subsystems, wherein the activated backup function compensates at least partially to a degree of compensation for the detected fault. An additional attempt is therefore made to compensate for the fault at least proportionally in order to be able to maintain the driving operation as safely as possible, even with an adapted mission or route or setpoint trajectory.

It can then preferably additionally be provided that the mission specification and/or the route specification and/or the setpoint trajectory is/are adapted depending on the degree of compensation to which the backup function can compensate for the reduced functional level of the subsystem concerned. As a result, if the fault can be (at least proportionally) compensated in some other way, the mission or route or setpoint trajectory can be adapted to a lesser extent. A “stronger” or “weaker” mitigation measure or fault response can therefore be chosen, depending on the degree of compensation of the respective backup function.

It can preferably be provided that the mission specification and/or the route specification and/or the setpoint trajectory is/are adapted in such a way, preferably depending on the degree of compensation of the backup function and/or the remaining functional level of the subsystem concerned, that, following the adaptation of the mission specification and/or the route specification and/or the setpoint trajectory, the vehicle then moves only on roads and/or to a destination point with a specified road surface characteristic. It can therefore advantageously be specified that, as a mitigation measure, the vehicle moves only on road surfaces that are correspondingly usable at the reduced (compensated) functional level.

It can be provided, for example, that a gradient and/or a road surface condition and/or a coefficient of friction and/or a bend and/or a change in the bend of the road and/or the destination point are specified as the road surface characteristic, preferably depending on the degree of compensation of the backup function and/or the remaining functional level of the subsystem concerned. Thus, in the event of a subsystem failure adversely affecting stability in the longitudinal or transverse direction, only routes on which stability-critical situations in the longitudinal or transverse direction can no longer occur or can be avoided can be used as mitigation measures.

It can thus preferably be provided that the mission specification and/or the route specification and/or the setpoint trajectory is/are adapted such that the vehicle, which is autonomously controlled depending thereon, moves only on roads and/or to a destination point on which:
the gradient falls below a limit gradient, and/or
the coefficient of friction exceeds a specified limit coefficient of friction, and/or
the bend falls below a bend limit, and/or
the change in the bend falls below a change limit,
wherein the limit gradient and/or the limit coefficient of friction and/or the bend limit value and/or the change limit value are specified depending on the degree of compensation of the backup function and/or the remaining functional level of the subsystem concerned.

Only slightly curved routes, for example, can therefore be driven in the event of (partial) failure of the cross stabilization, or routes having a low gradient, in the event of (partial) failure of the brakes or the drive, in order to avoid stability-critical situations in the event of a fault and still continue the operation of the vehicle. An appropriate response to the reduced functional capability in the situation concerned is thus advantageously ensured.

Furthermore, it can preferably be provided that the mission specification and/or the route specification and/or the setpoint trajectory is/are adapted in such a way, preferably depending on the degree of compensation of the backup function and/or the remaining functional level of the subsystem concerned, that the vehicle, following the adaptation of the mission specification and/or the route specification and/or the setpoint trajectory, moves only on roads and/or to a destination point on which an external ambient interference variable, for example a crosswind strength, falls below an interference variable limit value. Further external interference variables affecting the defective driving operation can also be taken into account accordingly.

Furthermore, it can preferably be provided that the adaptation of the mission specification and/or the route specification and/or the setpoint trajectory takes into account a failure probability for a failure of the remaining backup function. An assessment is therefore advantageously carried out to determine how robust the impact of the degree of compensation is and whether this could possibly also be discontinued at some stage during the mitigation measure. This then has a corresponding impact on the chosen mitigation measure or fault response, in particular the adaptation of the route or mission.

Furthermore, it can preferably be provided that the vehicle has, as a subsystem, at least one parking brake system having at least one pneumatically operated spring-loaded brake and/or a service braking system having at least one pneumatically operated service brake, wherein the at least one spring-loaded brake and/or the at least one service brake are pneumatically operated with pressure means from a pressure means supply. According to one preferred embodiment, it can then be provided that, if a parking brake fault is detected in the parking brake system of the vehicle, due to which the at least one spring-loaded brake cannot be activated, or can be activated to a limited extent only, by a parking brake control unit, a backup function is provided, whereby, instead of the at least one spring-loaded brake or in addition to the at least one spring-loaded brake, the at least one service brake of the service braking system is activated such that the detected parking brake fault is compensated at least partially to a degree of compensation. When the mitigation measure or fault response is selected, it is also taken into account that the service brake can be applied to replace or compensate for the (reduced or failed) parking brake function while the vehicle is traveling the route or carrying out the mission.

In particular, it can be provided that the at least one spring-loaded brake and the at least one service brake are pneumatically operated with pressure means from the same pressure means supply, wherein the backup function is provided by activating the at least one service brake of the service braking system once or repeatedly such that a supply pressure of the pressure means supply is reduced to a limit supply pressure, wherein the at least one spring-loaded brake is closed or applied on reaching or falling below the limit supply pressure in order to compensate at least partially to a degree of compensation for the detected parking brake fault. The pressure means supply is thus “drained” by activating the service brake so that the truck can still be safely parked using the parking brake, even if the parking brake cannot be activated, or can be activated to a limited extent only. In this way, the route planning or mission planning can be adapted according to the degree of compensation that is to be achieved thereby and even then a safe parking or a safe parking facility can be guaranteed.

Furthermore, it can preferably be provided that the backup function is provided by activating the at least one service brake of the service braking system such that the vehicle is kept stationary only via the at least one service brake in order to compensate for the detected parking brake fault, wherein the remaining amount of pressure means with which the at least one service brake is pneumatically operated is preferably taken into account in determining the degree of compensation of the backup function to which the detected parking brake fault is compensated at least partially to a degree compensation. An assessment is therefore also carried out to determine how long the service brake could replace a parking brake function in order to keep the vehicle stationary on the route or during the mission, for example until a repair can be carried out. The mitigation measure or fault response can then fail accordingly.

Furthermore, it can preferably be provided that, if a service brake fault is detected in the service braking system of the vehicle, due to which the at least one service brake cannot be activated, or can be activated to a limited extent only, by a service brake control unit and/or due to which a stability control system of the service braking system cannot be operated, or can be operated to a limited extent only, depending on the degree of compensation of the respectively activated backup function and/or the remaining functional level of the service braking system and/or the fault class of the service brake fault, at least one driving dynamics variable of the vehicle is provided, which is selected from the group consisting of: lateral acceleration, longitudinal acceleration, vehicle speed, steering angle, steering angle gradient, steering speed, steering torque. As a mitigation measure, it can also be specified that the vehicle will continue to be operated under certain driving dynamics restrictions only, in order to respond accordingly to a fault of a certain fault class.

Furthermore, it can preferably be provided that, if a steering system fault is detected in a steering system of the vehicle, due to which a steering request cannot be automatically implemented, or can be implemented to a limited extent only, a backup function is provided, whereby the service braking system causes a laterally different braking of the vehicle such that the vehicle is steered depending on the steering request in order to compensate at least partially to a degree of compensation for the detected steering system fault. The mitigation measure can also be determined accordingly, depending on the extent to which the defective steering function can be compensated via steering braking.

Furthermore, it can preferably be provided that the mission specification and/or the route specification and/or the setpoint trajectory is/are adapted such that the vehicle is automatically brought to a standstill following the adaptation of the mission specification and/or the route specification and/or the setpoint trajectory within a remaining time, wherein the remaining time is determined depending on the degree of compensation of the backup function and/or the remaining functional level of the subsystem concerned. Advantageously, the defective continued operation of the vehicle is not therefore permitted in the long term, even with compensation, in order to minimize the risk due to the fault and possibly further faults resulting therefrom.

Furthermore, it can preferably be provided that, if a fault is detected in at least one of the subsystems, a warning is generated and output to other road users, preferably via a V2X connection, wherein the warning is generated depending on the fault class of the respective fault. Surrounding traffic can therefore be warned, especially in the case of an automated vehicle, so that surrounding traffic can itself also react with due caution if, for example, a serious fault occurs.

Furthermore, it can preferably be provided that the vehicle has at least one trailer, wherein the trailer is monitored for the presence of a trailer fault, and in the event that a trailer fault has been detected in the monitored trailer, due to which the trailer can then be operated at a reduced functional level only, the trailer fault is classified into a fault class, and the mission specification and/or the route specification and/or the setpoint trajectory is/are adapted depending on the fault class of the trailer fault. The trailer itself can therefore be considered as an additional subsystem for which a corresponding mitigation measure can be initiated in the event of a fault of a particular fault class.

In this case, it can be provided, in particular, that the mission specification and/or the route specification and/or the setpoint trajectory is/are adapted such that the trailer is transferred to a parked state and, depending on the fault class and/or the remaining functional level of the trailer, is separated from the vehicle. As a result, the towing vehicle can continue to be operated, for example, and the route or mission can be continued even without the trailer, depending on the fault class.

Furthermore, it can preferably be provided that the at least one monitored subsystem of the vehicle is selected from the group consisting of:
a drive system, in particular having a transmission system, an engine system, and a differential system,
a wheel system, in particular having a wheel end and a tire,
a suspension system, in particular an electronic air suspension system,
an environment detection system, for example, having a camera, a laser sensor, and a LIDAR sensor,
a localization system, for example, satellite positioning.

Fault monitoring and classification are accordingly also possible for a number of further subsystems of the vehicle which are important for operation, wherein a corresponding mitigation measure is taken in response to a fault.

### BRIEF DESCRIPTION OF DRAWINGS

The invention will now be described with reference to the drawings wherein:

FIG. 1 shows a schematic view of a vehicle having a plurality of subsystems; and,

FIG. 2 shows a flow diagram of the method according to the disclosure,

### DETAILED DESCRIPTION

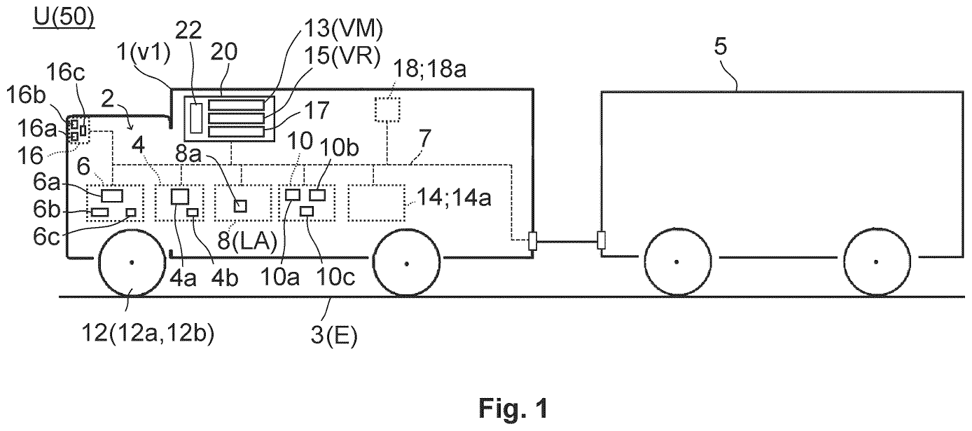

FIG. 1 shows a highly schematic view of a vehicle 1 having a plurality of subsystems 2, that is,
a service braking system 6 having service brakes 6a and a stability control system 6b and a service brake control unit 6c for the electrical control of the service braking system 6,
a parking brake system 4 having spring-loaded brakes 4a and a parking brake control unit 4b for the electrical control of the parking brake system 4,
an automated steering system 8 having an electrically activatable steering actuator 8a,
a drive system 10, in particular having a transmission system 10a, an engine system 10b, and a differential system 10c,
at least four wheel systems 12, in each case having, in particular, a wheel end 12a and a tire 12b,
a suspension system 14, in particular an electronic air suspension system 14a,
an environment detection system 16, for example, having a camera 16a, a laser sensor 16b, a LIDAR sensor 16c, et cetera, and,
a localization system 18, for example, a satellite location system 18a, in particular GPS, GLONASS, et cetera.

Other subsystems 2 (not specified) can also be provided in the vehicle 1. The vehicle 1 shown moves on a road 3 having a certain road surface characteristic E, for example, having a certain gradient EN, having a certain road surface condition EB (gravel, asphalt, snow, rain), having a certain coefficient of friction ER, having a certain bend EK or a corresponding change of bend EKA.

Furthermore, a motion control unit 20 is provided, into which a mission planning system 13, a route planning system 15 and a trajectory control system 17 are integrated. The mission planning system 13 is used to record or read in a mission specification VM, for example “Delivery of freight from a starting point A to a destination point Z”. The route planning system 15 is used to determine or read in a route specification VR, which includes the planned path of the vehicle 1 along a certain route from the starting point A to the destination point Z, preferably in the form of a setpoint trajectory TSoll, along which the vehicle 1 is intended to move from A to Z. The above-mentioned road surface characteristics E can also be assigned to the starting point A and the destination point Z.

The trajectory control system 17 ensures that the respective subsystems 2 in the vehicle 1 are activated, or that communication takes place with specific subsystems 2 in the vehicle 1, preferably via a serial data connection, in particular a data bus system 7, preferably a CAN bus, to make the vehicle 1 move along the setpoint trajectory TSoll, This is done by using the respective subsystems 2 (braking system (4, 6), drive system 10, steering system 8, wheel system 12, suspension system 14, and, if necessary, further subsystems 2), which influence or co-determine the movement of the vehicle 1, and through communication with the respective subsystems 2 (environment detection system 16, localization system 18, and, if necessary, further subsystems 2), which are involved in monitoring the vehicle 1, that is, observing the environment U and localizing the vehicle 1. Accordingly, a fully automated or autonomous control, preferably according to SAE level 4 or 5, can take place, in which the vehicle 1 is driven without a driver or without recourse to a driver along the setpoint trajectory TSoll, and this movement is monitored in terms of whether the setpoint trajectory TSoll is observed and/or collisions with other road users 50 are avoided. The movement of the vehicle 1 is thus coordinated centrally and autonomously by the motion control unit 20.

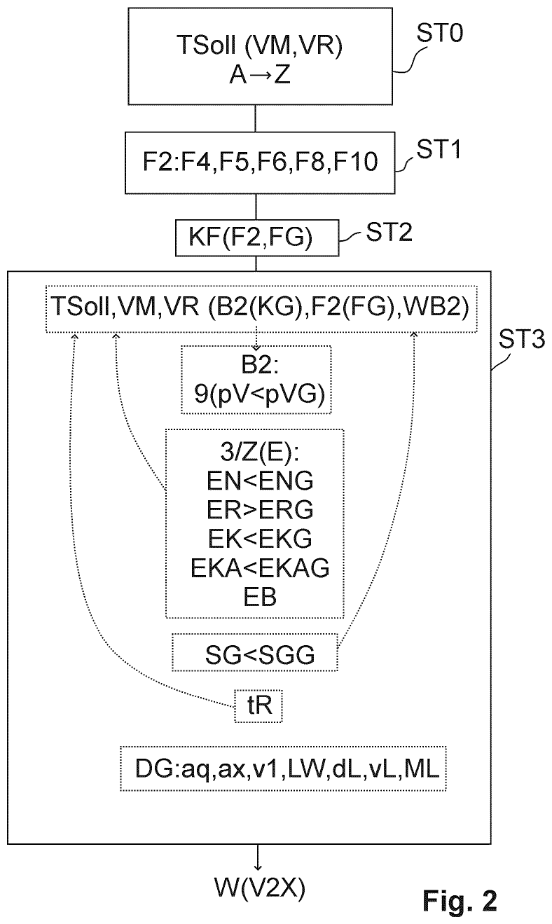

A monitoring system 22 is further provided, via which the autonomous operation of the vehicle 1 is permanently monitored, wherein the monitoring system 22 can, for example, be part of the motion control unit 20 or can at least exchange data with it to enable a response, as described below, to a detected fault F2 in one or more of the subsystems 2 or to a degraded availability of the respective subsystem 2. The method shown by way of example in FIG. 2 is provided for this purpose:
it is provided accordingly that, following an initial (STO) determination of the setpoint trajectory TSoll depending on the mission specification VM and/or the route specification VR by the motion control unit 20, continuous fault monitoring takes place in a monitoring step ST1, while the vehicle 1 is automatically controlled via the trajectory control system 17 depending on the setpoint trajectory TSoll. In the fault monitoring, at least one of the subsystems 2 of the vehicle 1 is monitored for the presence of a fault F2 or for the availability of the respective subsystem 2.

If a fault F2 has been detected in at least one of the monitored subsystems 2, due to which the subsystem 2 concerned can consequently be operated at a reduced functional level FG only, that is, no longer completely as in normal operation, the at least one fault F2 is then classified or assigned to a fault class KF in a classification step ST2. The mission specification VM and/or the route specification VR and/or the setpoint trajectory TSoll is/are then adapted accordingly in an adaptation step ST3.

The route or the mission is thus adapted according to the detected fault F2, wherein, if a fault F2 is detected in the at least one monitored subsystem 2 and depending on the fault class KF of the fault F2, a backup function B2 is activated either by the subsystem 2 itself affected by the fault F2 and/or by one of the other subsystems 2. The activated backup function B2 is then used to equalize or compensate for the detected fault F2 at least partially, but preferably completely (insofar as possible), to a certain degree of compensation KG.

It can thus be provided, for example, that, if a parking brake fault F4 is detected in the parking brake system 4 of the vehicle 1, due to which, for example, the spring-loaded brakes 4a cannot be controlled, or can be controlled to a limited extent only, by the parking brake control unit 4b, a backup function B2 is provided, whereby, instead of the at least one spring-loaded brake 4a or (if it is still controllable to a reduced extent) in addition to the at least one spring-loaded brake 4a, the at least one service brake 6a of the service braking system 6 is activated. The complete or partial failure of the parking brake system 4 is thus compensated by the use of the service braking system 6.

In particular, it can be provided that, if the at least one spring-loaded brake 4a and the at least one service brake 6a are operated pneumatically with pressure means from the same pressure means supply 9, the backup function B2 is provided, whereby the pressure means is “consumed” by activating the at least one service brake 6a. The at least one service brake 6a of the service braking system 6 is thus activated once or repeatedly such that a supply pressure pV of the shared pressure means supply 9 is reduced to a limit supply pressure pVG, for example ambient pressure, wherein the at least one spring-loaded brake 4a is closed or applied when reaching or falling below the limit supply pressure pVG. In this way, the defective activation via the parking brake control unit 4b can be compensated in that the pressure means supply 9 is “drained” by activating the service brake 6a, as a result of which the spring-loaded brake 4a can no longer be held in the open position.

It can also be provided that the backup function B2 for a parking brake fault F4 is provided by activating the at least one service brake 6a of the service braking system 6 such that the vehicle 1 is kept stationary only via the at least one service brake 6a. For example, the remaining amount of pressure means with which the at least one service brake 6a is pneumatically operated can be taken into account in order to determine the degree of compensation KG of the backup function B2. Depending on this, it is then possible to estimate, for example, how long the vehicle 1 can be kept securely stationary via the service brake 6a until the vehicle 1 can be secured against rolling away through an external intervention, that is, not by the automated vehicle 1 itself, for example, by an (automatically) requested breakdown assistant/operator/towing service. This backup function F2 is therefore considered only if it is ensured that the pressure means is available in sufficient quantity (including a safety margin) to securely bridge the required time window with this emergency operation. Only then can a backup function B2 be provided with a sufficiently high degree of compensation KG.

Furthermore, if a steering system fault F8 is detected in a steering system 8 of the vehicle 1, due to which a steering request LA cannot be automatically implemented, or can be implemented to a limited extent only, via the steering actuator 8a, a backup function B2 can be provided by controlling the service brakes 6a of the service braking system 6 differently from one side to the other in order to achieve, at least partially, a steering (by braking) depending on the respective steering request LA. The detected steering system fault F4 can therefore be compensated, at least partially, by this steering braking to a certain degree of compensation KG.

If a drive fault F10 or a service brake fault F6 is present in the drive system 10 or in the service braking system 6, due to which the respective subsystem 2; 10, 6 can be operated to a limited extent only, a backup function B2 can be provided, whereby the vehicle 1 is driven or braked via the respective subsystem 2; 10, 6 to a limited extent only, for example via a redundant path, or is driven or braked (to a restricted extent) via corresponding equivalent exchange means in the vehicle 2, then (to a correspondingly restricted extent) with a corresponding degree of compensation KG.

As a result of the use of the backup function B2, limitations or restrictions normally apply to the respective function of the defective subsystem 2, that is, for example, the parking brake function or service brake function or steering function or drive function or the like, and therefore the function of the vehicle 1 in general.

Depending on the degree of compensation KG to which the respective backup function B2 can compensate for the reduced functional level FG of the defective subsystem 2 concerned, the route or the route specification VR and/or the mission or the mission specification MV and therefore also the setpoint trajectory TSoll are adapted accordingly. The vehicle 1 is therefore diverted accordingly or sent on a different route in order to take account of the limitations from the backup function B2.

For this purpose, it can be provided, for example, that the mission specification VM and/or the route specification VR and/or the setpoint trajectory TSoll is/are adapted such that the vehicle 1, following the adaptation step ST3, moves only on roads 3 and/or to a destination point Z having a specified road surface characteristic E. Depending on the respective limitation due to the activation of the respective backup function B2, a gradient EN, for example, and/or a road surface condition EB, for example, gravel, asphalt, snow, rain, and/or a coefficient of friction ER and/or a bend EK and/or a change in the bend EKA can be specified as a road surface characteristic E for the road 3 or the destination point Z. Depending, in particular, on the degree of compensation KG of the backup function B2 and/or the remaining functional level FG of the subsystem 2 concerned, the further route or mission of the vehicle 1 can thus be specified such that the resulting setpoint trajectory TSoll can be driven without problems with the remaining and (possibly restricted) function of the subsystems 2. It is also possible to take account of the effects that the occurrence of further faults F2 in the same or further subsystems 2 or the failure of the respectively activated backup function B2 would have, or how high the probability of failure WB2 of the respective backup function B2 is.

Thus, for example, it can be taken into account, following the adaptation step ST3, that the vehicle 1 moves only on roads 3 and/or to a destination point Z on which the gradient EN is below a limit gradient ENG, so that, in the event of a parking brake fault F4 and/or a service brake fault F6 with a reduced functional level FG of the service braking system 6, the vehicle 2 cannot end up in a situation in which it needs to brake permanently (parking brake) or temporarily (service brake subsystem) on a road surface that is rising or falling too steeply (road 3, destination point Z). Correspondingly, this may be the case if a drive fault F10 occurs in which the drive system 10 continues to be operated with a reduced functional level FG and therefore in some instances not all transmission ratios and/or only limited drive torques are available, which does not enable, or only conditionally enables, driving on certain road surfaces with certain gradients EN.

Furthermore, it can be taken into account, following the adaptation step ST3, that the vehicle 1 moves only on roads 3 and/or to a destination point Z on which the coefficient of friction ER exceeds a specified limit coefficient of friction ERG. In this way, for example in the event of a service brake fault F6 in the service braking system 6 and/or in the event of a drive fault F10 in the drive system 10, the vehicle 1 can avoid a situation resulting in an unwanted loss of stability, which can essentially occur due to the reduced functional level FG or the respective degree of compensation KG of the respectively activated backup function B2.

Furthermore, it can be taken into account, following the adaptation step ST3, that the vehicle 1 moves only on roads 3 and/or to a destination point Z on which the bend EK falls below/exceeds a bend limit value EKG and/or the change in the bend EKA below/exceeds a change limit value EKAG below/below. In this way, for example in the event of a steering system fault F8 in the steering system 8, the vehicle 1 can avoid being automatically maneuvered onto a road 3 or to a destination point Z in which a steering movement of the vehicle 1 is to be requested which, for example, cannot be achieved via steering braking via the service braking system 6 as a backup function B2.

The route or the mission or the setpoint trajectory TSoll can thus be adapted accordingly to this limitation, wherein the specified limit values, that is, the limit gradient ENG and/or the limit coefficient of friction ERG and/or the bend limit value EKG and/or the change limit value EKAG are specified depending on the degree of compensation KG of the backup function B2 and/or the remaining functional level FG of the subsystem 2 concerned. In addition, external ambient interference variables SG on the route to the destination point Z can also be taken into account, for example a crosswind strength, which should not exceed an interference variable limit value SGG if, for example, the stability control system 6b within the service braking system 6 has a fault F2 and therefore cannot react to stronger gusts. Driving over lengthy bridges or adjacent to open spaces can therefore be taken into account during the adaptation in adaptation step ST3.

If a service brake fault F6 is detected in the service braking system 6 of the vehicle 1, due to which the at least one service brake 6a cannot be controlled, or can be controlled to a limited extent only, by a service brake control unit 6c, and/or due to which the stability control system 6b of the service braking system 6 cannot be operated, or can be operated to a limited extent only, and/or also in the event of a drive fault F10 in the drive system 10, the limitation resulting from the recourse to the respective backup function B2 can be taken into account by limiting at least one driving dynamics variable DG of the vehicle 1. A lateral acceleration aq, for example, and/or a longitudinal acceleration ax and/or a vehicle speed v1 and/or a steering angle LW and/or a steering angle gradient dL and/or a steering speed vL and/or a steering torque ML can be limited as the driving dynamics variable DG. In this way, it can be taken into account that too much intervention in the driving dynamics of the vehicle 1 due to the recourse to the respective backup function B2 to compensate for the respective F2 fault can possibly lead to stability-critical situations that cannot be compensated. This can be taken into account not only in the adaptation step ST3, for example by avoiding roads 3 or destination points Z with excessively high minimum speeds (highways) or excessively sharp bends, but also in the subsequent automated control of the vehicle 1 along the already adapted setpoint trajectory TSoll, which is then traveled, for example, at a reduced vehicle speed v1 and/or with an acceleration that is not excessively sharp,

In all the above-mentioned embodiments of the backup functions B2 and the responses to them, it can additionally be taken into account in the adaptation step ST3 that the vehicle 1 is automatically brought to a standstill within a remaining time tR following the adaptation of the mission specification VM and/or the route specification VR and/or the setpoint trajectory TSoll. A residual time tR is therefore defined for safety reasons, within which the vehicle is safely parked, even if a sufficient degree of compensation KG is provided by the respective backup function B2, at the roadside or in a workshop, in order to rectify or validate the respectively detected fault F2. It is then also provided accordingly that the residual time tR is defined depending on the degree of compensation KG of the respective backup function B2 and/or the remaining functional level FG of the subsystem 2 concerned. If the fault F2 has a greater impact on the functionality of the vehicle 1, that is, if the remaining functional level FG is lower, and/or this fault can be compensated to a higher degree by the backup function B2, that is, if the degree of compensation KG is higher, a longer residual time tR can be selected, since only little degradation can be assumed. Conversely, the degradation is correspondingly higher and the vehicle 1 is therefore parked even earlier so as not to endanger surrounding road users 50.

In order to similarly inform surrounding road users 50 that the operation of the vehicle 1 is defective, this can be output in a warning W to the other road users 50, preferably via a V2X connection V2X. The warning W is then preferably generated depending on the fault class KF of the respective fault F2 or depending on the reduced functional level FG or the degree of compensation KG, that is, depending on the urgency of warning the other road users 50.

In a further embodiment, it can also be provided that if a trailer 5 is attached to the vehicle 1, this trailer 5 can also be monitored for the presence of a trailer fault F5. If a trailer fault F5 was detected in the respectively monitored trailer 5 in this monitoring step ST1, due to which the trailer 5 can be operated only at a reduced functional level FG, the trailer fault F5 is classified in a classification step ST2 into an fault class KF.

Subsequently, in an adaptation step ST3, the mission specification VM and/or the route specification VR and/or the setpoint trajectory TSoll is/are adapted depending on the fault class KF of the trailer fault F5. In this way, it is also possible to respond to such a trailer fault F5 limiting the driving operation of the vehicle 1, and the vehicle 1 can be controlled automatically with a different mission or on a different route.

If a corresponding fault class FK or a certain reduced functional level FG of the trailer 5 occurs, the mission specification VM and/or the route specification VR and/or the setpoint trajectory TSoll can also be adapted such that the trailer 5, together with the vehicle 1, is transferred to a parked state and, if necessary, is also separated from the vehicle 1. In this way, the vehicle 1 can at least continue its journey without the trailer 5.

In this way, the further subsystems 2 of the vehicle 1 and, if necessary, their subsystems or components can also be monitored in order to then respond with an adaptation in the event of the corresponding fault F2.At least one specification heading is required.

It is understood that the foregoing description is that of the preferred embodiments of the invention and that various changes and modifications may be made thereto without departing from the spirit and scope of the invention as defined in the appended claims.

### REFERENCE SIGNS (PART OF THE DESCRIPTION)

1 Vehicle
2 Subsystems of the vehicle 1
3 Road
4 Parking brake system
4a Spring-loaded brake
4b Parking brake control unit
5 Trailer
6 Service braking system
6a Service brake
6b Stability control system
6c Service brake control unit
7 Data bus system
8 Steering system
8a Steering actuator
9 Pressure means supply
10 Drive system
10a Transmission system
10b Engine system
10c Differential system
12 Wheel system
12a Wheel end
12b Tire
13 Mission planning system
14 Suspension system
14a Electronic air suspension system
15 Route planning system
16 Environment detection system
16a Camera
16b Laser sensor
16c LIDAR sensor 18
17 Trajectory control system
18 Localization system
18a Satellite positioning system
20 Motion control unit
22 Monitoring system
50 Road users
A Starting point
Lateral acceleration
ax Longitudinal acceleration
B2 Backup function
DG Driving dynamics variable
dL Steering angle gradient
E Road surface characteristic
EN Gradient
ENG Limit gradient
EB Road surface condition
ER Coefficient of friction
ERG limit coefficient of friction
EK Bend
EKG Bend limit value
EKA Change in bend
EKAG Change limit value
F2 Fault in subsystem 2
F4 Parking brake fault
F5 Trailer fault
F6 Service brake fault
F8 Steering system fault
F10 Drive fault
FG Functional level of the subsystem 2
KF Fault class
KG Degree of compensation
LA Steering request
LW Steering angle
ML Steering torque
PV Supply pressure of the pressure means supply 9
pVG Limit supply pressure
SG Ambient interference variable
SGG Interference limit value
tR Remaining time
TSoll Setpoint trajectory
U Environment of the vehicle 1
v1 Vehicle speed
VL Steering angle speed
VM Mission specification
VR Route specification
V2X V2X connection
W Warning
WB2 Probability of failure of backup function B2
Z Destination point
ST1 Monitoring step
ST2 Classification step
ST3 Adaptation step

1. A method for controlling a vehicle having a plurality of subsystems, wherein the vehicle is autonomously controlled by a motion control unit, wherein the motion control unit is configured to determine a setpoint trajectory depending on at least one of a mission specification and a route specification and to at least one of communicate with at least some of the plurality of subsystems and activate at least some of the plurality of subsystems depending on the setpoint trajectory such that the vehicle moves along a road from a starting point to a destination point in order to implement the at least one of the mission specification and the route specification, the method comprising:
monitoring at least one of the plurality of subsystems of the vehicle for the presence of a fault and, if at least one fault has been detected in the at least one monitored subsystem, as a result of which the subsystem concerned can be operated only at a reduced functional level:
classifying at least one fault into a fault class; and,
adapting at least one of the mission specification, the route specification, and the setpoint trajectory depending on the fault class of the at least one detected fault.

2. The method of claim 1, wherein, if the at least one fault is detected in the at least one monitored subsystem, due to which the corresponding subsystem is operable at a reduced functional level only, a backup function is activated by at least one of the corresponding subsystem and another of the plurality of subsystems, wherein the activated backup function compensates at least partially to a degree of compensation for the detected fault.

3. The method of claim 2, wherein at least one of the mission specification, the route specification, and the setpoint trajectory is adapted depending on the degree of compensation to which the backup function is able to compensate for the reduced functional level of the subsystem concerned.

4. The method of claim 2, wherein at least one of the mission specification, the route specification, and the setpoint trajectory is adapted such that the vehicle, following the adaptation of the at least one of the mission specification, the route specification, and the setpoint trajectory moves only on roads and/or to the destination point with a specified road surface characteristic.

5. The method of claim 2, wherein at least one of the mission specification, the route specification, and the setpoint trajectory is adapted depending on at least one of the degree of compensation of the backup function and a remaining functional level of the corresponding subsystem, such that the vehicle, following the adaptation of the at least one of the mission specification, the route specification, and the setpoint trajectory moves only on roads and/or to the destination point with a specified road surface characteristic.

6. The method of claim 4, wherein at least one of a gradient, a road surface condition, a coefficient of friction, a bend of the road, a change in the bend of the road, and the destination point are specified as the road surface characteristic.

7. The method of claim 4, wherein at least one of a gradient, a road surface condition, a coefficient of friction, a bend of the road, a change in the bend of the road, the destination point are specified as the road surface characteristic depending on at least one of the degree of compensation of the backup function and the remaining functional level of the corresponding subsystem.

8. The method of claim 6, wherein at least one of the mission specification, the route specification, and the setpoint trajectory is such that the vehicle which is autonomously controlled depending thereon moves at least one of only on the roads and to the destination point on which at least one of:
the gradient falls below a limit gradient;
the coefficient of friction exceeds a specified limit coefficient of friction;
the bend falls below a bend limit; and,
the change in the bend falls below a change limit value;
wherein at least one of the limit gradient, the limit coefficient of friction value, the bend limit value, and the change limit value is specified depending on the degree of compensation of the backup function and/or the remaining functional level of the corresponding subsystem.

9. The method of claim 2, wherein at least one of the mission specification, the route specification, and the setpoint trajectory is adapted such that the vehicle, following the adaptation of the at least one of the mission specification, the route specification, and the setpoint trajectory, moves only at least one of on the road and to the destination point on which an external ambient interference variable falls below an interference variable limit value.

10. The method of claim 9, wherein the external ambient interference variable is a crosswind strength.

11. The method of claim 2, wherein at least one of the mission specification, the route specification, and the setpoint trajectory is adapted such that, depending on the degree of compensation of at least one of the backup function and the remaining functional level of the corresponding subsystem, the vehicle, following the adaptation of the at least one of the mission specification, the route specification, and the setpoint trajectory, moves only at least one of on the road and to the destination point on which an external ambient interference variable falls below an interference variable limit value.

12. The method of claim 2, wherein said adaptation of the at least one of the mission specification, the route specification, and the setpoint trajectory takes into account a failure probability of a failure of a remaining backup function.

13. The method of claim 2, wherein the plurality of subsystems includes at least one parking brake system having at least one of at least one pneumatically operated spring-loaded brake and a service braking system having at least one pneumatically operated service brake; and, the at least one of the at least one spring-loaded brake and the at least one service brake is pneumatically operated with pressure from a pressure supply.

14. The method of claim 13, wherein, if a parking brake fault is detected in the at least one parking brake system of the vehicle, due to which the at least one spring-loaded brake cannot be activated, or can be activated to a limited extent only, by a parking brake control unit, a backup function is provided, whereby, instead of the at least one spring-loaded brake or in addition to the at least one spring-loaded brake, the at least one service brake of the service braking system is activated such that the detected parking brake fault is compensated at least partially to a degree of compensation.

15. The method of claim 14, wherein the at least one spring-loaded brake and the at least one service brake are pneumatically operated with pressure from the pressure supply, wherein the backup function is provided by activating the at least one service brake of the service braking system once or repeatedly such that a supply pressure of the pressure is reduced to a limit supply pressure, wherein the at least one spring-loaded brake is closed or applied on reaching or falling below the limit supply pressure in order to compensate at least partially to a degree of compensation for the detected parking brake fault.

16. The method of claim 14, wherein the backup function is provided by activating the at least one service brake of the service braking system such that the vehicle is kept stationary only via the at least one service brake in order to compensate for the detected parking brake fault.

17. The method of claim 16, wherein the remaining amount of pressure with which the at least one service brake is pneumatically operated is taken into account in determining the degree of compensation of the backup function to which the detected parking brake fault is compensated at least partially to the degree of compensation.

18. The method of claim 13, wherein, if a service brake fault is detected in the service braking system of the vehicle, due to which the at least one service brake cannot be activated, or can be activated to a limited extent only, by a service brake control unit and/or due to which a stability control system of the service braking system cannot be operated, or can be operated to a limited extent only, depending on at least one of the degree of compensation of the respectively activated backup function, the remaining functional level of the service braking system, and the fault class of the service brake fault, at least one driving dynamics variable of the vehicle is provided, which is selected from the group including: lateral acceleration, longitudinal acceleration, vehicle speed, steering angle, steering angle gradient, steering speed, and steering torque.

19. The method of claim 13, wherein, if a steering system fault is detected in a steering system of the vehicle, due to which a steering request cannot be automatically implemented, or can be implemented to a limited extent only, a backup function is provided, whereby the service braking system causes a laterally different braking of the vehicle such that the vehicle is steered depending on the steering request in order to compensate at least partially to a degree of compensation for the detected steering system fault.

20. The method of claim 2, wherein at least one of the mission specification, the route specification, and the setpoint trajectory is adapted such that the vehicle is automatically brought to a standstill following the adaptation of the at least one of the mission specification, the route specification, and the setpoint trajectory within a remaining time; and, the remaining time is determined depending on at least one of the degree of compensation of the backup function and the remaining functional level of the corresponding subsystem.

21. The method of claim 1 further comprising, if a fault is detected in at least one of the plurality of subsystems, generating a warning and outputting the warning to other road users, wherein the warning is generated depending on the fault class of the respective fault.

22. The method of claim 21, wherein said warning is outputted via a V2X connection.

23. The method of claim 1, wherein the vehicle has at least one trailer, the method further comprising:
monitoring the trailer for the presence of a trailer fault; and,
in the event that a trailer fault has been detected in the trailer being monitored, due to which the trailer can then be operated at a reduced functional level only, the trailer fault is classified into a fault class, and the at least one of the mission specification, the route specification, and the setpoint trajectory is adapted depending on the fault class of the trailer fault.

24. The method of claim 23, wherein the at least one of the mission specification, the route specification, and the setpoint trajectory is adapted such that the trailer is transferred to a parked state and, depending on at least one of the fault class and the remaining functional level of the trailer, is separated from the vehicle.

25. The method of claim 1, wherein the at least one monitored subsystem of the vehicle is selected from a group including:
a drive system; a drive system having a transmission system; an engine system; a differential system; a wheel system; a wheel system having a wheel end and a tire; a suspension system; an electronic air suspension system; an environment detection system; an environmental system having a camera, a laser sensor, and a LIDAR sensor; a localization system; and, a satellite positioning system.

26. A vehicle comprising:
a plurality of subsystems;
a motion control unit;
a monitoring system;
said motion control unit being configured to automatically determine a setpoint trajectory depending on at least one of a mission specification and a route specification, and to communicate automatically with at least some of the plurality of subsystems of the vehicle and/or to automatically activate at least some of the plurality of subsystems of the vehicle depending on the setpoint trajectory such that the vehicle moves along a road from a starting point to a destination point in order to implement the at least one of the mission specification and the route specification;
said monitoring system being configured to:
monitor at least one of the plurality of subsystems of the vehicle for the presence of a fault and, if at least one fault has been detected in the at least one monitored subsystem, as a result of which the subsystem concerned can be operated only at a reduced functional level:
classifying at least one fault into a fault class; and,
adapt at least one of the mission specification, the route specification, and the setpoint trajectory depending on the fault class of the at least one detected fault.
